(19) United States
(12) Patent Application Publication
(10) Pub. No.: US 2026/0287980 A1
(43) Pub. Date: Sep. 24, 2026

(54) IMAGING APPARATUS

(71) Applicant: CANON KABUSHIKI KAISHA, Tokyo (JP)

(72) Inventor: SEIYA MIZUNO, Tokyo (JP)

(21) Appl. No.: 19/568,390

(22) Filed: Mar. 16, 2026

(30) Foreign Application Priority Data
Mar. 19, 2025 (JP) 2025-044713

(51) Int. Cl. G03B 17/55; G03B 17/56

(52) U.S. Cl. CPC G03B 17/55; G03B 17/561

(57) ABSTRACT

An imaging apparatus includes an apparatus main body, an imaging unit, a first support unit rotatably connected to the apparatus main body, a second support unit rotatably connected to both the first support unit and the imaging unit, a first driver configured to rotate the first support unit with respect to the apparatus main body about a first axis, a second driver configured to rotate the second support unit with respect to the first support unit about a second axis orthogonal to the first axis, a third driver configured to rotate the imaging unit with respect to the second support unit about a third axis orthogonal to both the first and the second axis, and a controller configured to, in a non-imaging mode, control the first driver, the second driver, and the third driver so that the imaging unit is positioned in air flow generated by a forced air-cooling mechanism.

### BACKGROUND

### Field of the Technology

The present disclosure relates to an imaging apparatus.

### Description of the Related Art

In recent years, there have been widespread imaging apparatuses provided with a gimbal mechanism capable of handheld image capturing while camera shake is reduced. There is a growing demand for higher functionality and higher performance in such imaging apparatuses, and thus the power consumption and the amount of heat generated by such an imaging apparatus tend to increase. Meanwhile, there is also a strong demand for downsizing, leading to reduction in space to dissipate heat within the apparatus. Increased heat generation can result in malfunction of components inside the apparatus, failure of the apparatus, and degradation in image quality due to electrical noise, so that the apparatus is protected by restricting its functions when the apparatus reaches a predetermined temperature. With functions being restricted, the user cannot capture desired images, and thus the imaging apparatus may have high heat dissipation performance in order to extend the time before its moving image capturing function is restricted.

Japanese Patent Laid-Open No. 2013-085204 describes a configuration in which an internal temperature sensor and an external temperature sensor disposed inside a shielded housing in a surveillance camera provided with a pan-tilt head and an imaging apparatus are used to monitor the temperature inside and outside the housing to control the driving of a fan that circulates air inside the housing. Further, Japanese Patent Laid-Open No. 2006-345052 describes a configuration in which, when the temperature of an image sensor in an imaging apparatus exceeds a predetermined temperature, the image sensor is controlled to be driven to a position where the image sensor is thermally coupled to a cooling element.

However, the configuration described in Japanese Patent Laid-Open No. 2013-085204 entails a large housing to circulate air, and thus is difficult to apply to a relatively small imaging apparatus provided with a gimbal mechanism for handheld image capturing. Further, the configuration described in Japanese Patent Laid-Open No. 2006-345052 also entails a large housing to install a drive mechanism for thermally coupling the image sensor to the cooling element, and thus is difficult to apply to a small imaging apparatus.

### SUMMARY

The present disclosure is directed to increasing heat dissipation performance of a compact imaging apparatus provided with a gimbal mechanism for handheld image capturing, extending the time before the moving image capturing function is restricted.

According to some embodiments of the present disclosure, an imaging apparatus includes an apparatus main body, an imaging unit, a first support unit rotatably connected to the apparatus main body, a second support unit rotatably connected to both the first support unit and the imaging unit, a first driver configured to rotate the first support unit with respect to the apparatus main body about a first axis, a second driver configured to rotate the second support unit with respect to the first support unit about a second axis orthogonal to the first axis, a third driver configured to rotate the imaging unit with respect to the second support unit about a third axis orthogonal to both the first axis and the second axis, and a controller configured to, in a non-imaging mode, control the first driver, the second driver, and the third driver so that the imaging unit is positioned in air flow generated by a forced air-cooling mechanism.

Features of the present disclosure will become apparent from the following description of embodiments with reference to the attached drawings. The following description of embodiments is described by way of example.

### BRIEF DESCRIPTION OF THE DRAWINGS

FIG. 1 is a system block diagram of a gimbal camera according to a first embodiment.

FIG. 2A is an external view of the gimbal camera according to the first embodiment.

FIG. 2B is an external view of the gimbal camera according to the first embodiment.

FIG. 2C is a cross-sectional view of the gimbal camera according to the first embodiment.

FIG. 2D is a cross-sectional view of the gimbal camera according to the first embodiment.

FIG. 3 is a flowchart of operations of the gimbal camera according to the first embodiment.

FIG. 4A is a cross-sectional view of the gimbal camera according to the first embodiment.

FIG. 4B is a cross-sectional view of the gimbal camera according to the first embodiment.

FIG. 5A is an external view of the gimbal camera according to the first embodiment in a standby state for image capturing.

FIG. 5B is an external view of the gimbal camera according to the first embodiment after gimbal control.

FIG. 5C is a cross-sectional view of the gimbal camera according to the first embodiment in the standby state for image capturing.

FIG. 6 is a table illustrating the gimbal control based on a remaining battery level and an internal temperature of the gimbal camera according to the first embodiment.

FIG. 7 is a system block diagram of a gimbal camera according to a second embodiment.

FIG. 8A is an external view of the gimbal camera according to the second embodiment.

FIG. 8B is a cross-sectional view of the gimbal camera according to the second embodiment.

FIG. 9 is a system block diagram of a gimbal camera of a modification according to the second embodiment.

FIG. 10 is a cross-sectional view of the gimbal camera of the modification according to the second embodiment.

FIG. 11 is a system block diagram of a gimbal camera of a modification according to the second embodiment.

FIG. 12A is an external view of the gimbal camera of the modification according to the second embodiment.

FIG. 12B is a cross-sectional view of the gimbal camera of the modification according to the second embodiment.

FIG. 12C is a cross-sectional view of the gimbal camera of the modification according to the second embodiment.

FIG. 13 is a system block diagram of a gimbal camera of a modification according to the second embodiment.

FIG. 14A is an external view of the gimbal camera of the modification according to the second embodiment.

FIG. 14B is a cross-sectional view of the gimbal camera of the modification according to the second embodiment.

FIG. 15 is a system block diagram of a gimbal camera according to a third embodiment.

FIG. 16 is a flowchart of operations of the gimbal camera according to the third embodiment.

FIG. 17 is a cross-sectional view of the gimbal camera according to the third embodiment.

FIG. 18 is a table illustrating control on each valve opening diameter based on each temperature detection result according to the third embodiment.

FIG. 19 is a system block diagram of a gimbal camera according to a fourth embodiment.

FIG. 20A is a cross-sectional view of the gimbal camera according to the fourth embodiment.

FIG. 20B is an external view of the gimbal camera according to the fourth embodiment.

FIG. 20C is a cross-sectional view of the gimbal camera according to the fourth embodiment.

### DESCRIPTION OF THE EMBODIMENTS

Various exemplary embodiments, features, and aspects of the present disclosure will now be described in detail with reference to the attached drawings.

### First Embodiment

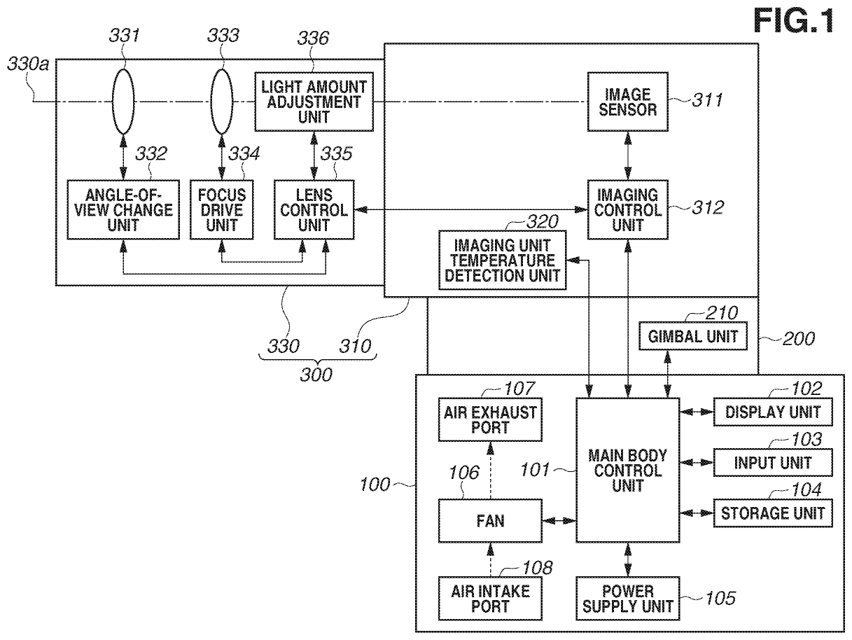

FIG. 1 illustrates a configuration of a gimbal camera of a first embodiment. The gimbal camera includes an apparatus main body 100, a gimbal mechanism 200, and a movable unit 300.

The movable unit 300 includes an imaging unit 310 and a lens unit 330, and the apparatus main body 100 movably (rotatably) supports the movable unit 300 via the gimbal mechanism 200.

The apparatus main body 100, the gimbal mechanism 200, and the movable unit 300 may be configured integrally or configured to be removable. The detachable movable unit 300 may be a general or general-purpose interchangeable-lens single-lens reflex camera, a mirrorless camera, a lens-integrated camera, a smartphone with a camera function, or the like, and any of those may be supported by the gimbal mechanism 200.

The apparatus main body 100 includes a main body control unit 101, a display unit 102, an input unit 103, and a storage unit 104. The main body control unit 101 is configured to control the gimbal camera, and controls each function described below. The display unit 102 displays moving images captured by the imaging unit 310, operation information input via the input unit 103, moving images stored in the storage unit 104, and the like, all of which are visually recognizable by the user.

The input unit 103 receives the user's operations, such as changing the imaging settings and playing back recorded images. The input unit 103 also receives operations of a gimbal unit 210, which is capable of changing the orientation of the movable unit 300 around three mutually orthogonal rotation axes described below, enabling a panning operation of the movable unit 300, and the like.

The storage unit 104 stores moving images captured by the imaging unit 310, operation information from the input unit 103, information from an imaging unit temperature detection unit 320 described below, and the like. The apparatus main body 100 also includes a power supply unit 105. The power supply unit 105 is a battery electrically connected to the main body control unit 101 to supply power to each function of the gimbal camera via the main body control unit 101. The power supply unit 105 transmits information about the remaining battery level to the main body control unit 101.

The apparatus main body 100 further includes a fan 106, an air exhaust port 107, and an air intake port 108. The main body control unit 101 controls the fan 106 to blow air from the air intake port 108 toward the air exhaust port 107. The fan 106 may be configured integrally with the apparatus main body 100, or may be configured to be removable like a fan accessory 600 described below in a second embodiment. The fan 106, the air exhaust port 107, and the air intake port 108 constitute a forced air-cooling mechanism.

The air exhaust port 107 discharges the air blown by the fan 106 to the outside of the gimbal camera. The air exhaust port 107 may be included in the apparatus main body 100 as in the second embodiment described below, or may be included in the gimbal mechanism 200 or in the imaging unit 310.

The air intake port 108 takes in air from the outside. In the present embodiment, the air intake port 108 is disposed at the lower position of the apparatus main body 100. However, the air intake port 108 may be disposed at the upper position, and various modifications and changes can be made within the gist of the present disclosure.

The gimbal mechanism 200 includes a gimbal unit 210 capable of changing the orientation of the movable unit 300 around three mutually orthogonal rotation axes described below. The gimbal unit 210 is electrically connected to the main body control unit 101, and is capable of performing image stabilization driving, the panning operation, and the like, of the movable unit 300 based on control information from the main body control unit 101.

An optical system in the lens unit 330 includes a plurality of optical elements, such as a zoom lens 331, a focus lens 333, and a light amount adjustment unit 336. The lens unit 330 includes an angle-of-view change unit 332 that drives the zoom lens 331 in the direction in which an optical axis 330a extends (an optical axis direction). The lens unit 330 also includes a focus drive unit 334 that drives the focus lens 333, and a lens control unit 335 that controls the angle-of-view change unit 332, the focus drive unit 334, and the light amount adjustment unit 336.

The imaging unit 310 includes an image sensor 311 that photoelectrically converts optical images formed by the optical system in the lens unit 330, an imaging control unit 312 that drives and controls the image sensor 311, and an imaging unit temperature detection unit 320 that detects temperature information about the imaging unit 310.

The imaging control unit 312 is electrically connected to the main body control unit 101 to transmit camera information including moving images obtained based on signals output from the image sensor 311 to the main body control unit 101. The imaging control unit 312 is also electrically connected to the lens control unit 335 to exchange various types of information with the lens control unit 335. The imaging unit temperature detection unit 320 is electrically connected to the main body control unit 101 to transmit the detected temperature information about the imaging unit 310 to the main body control unit 101.

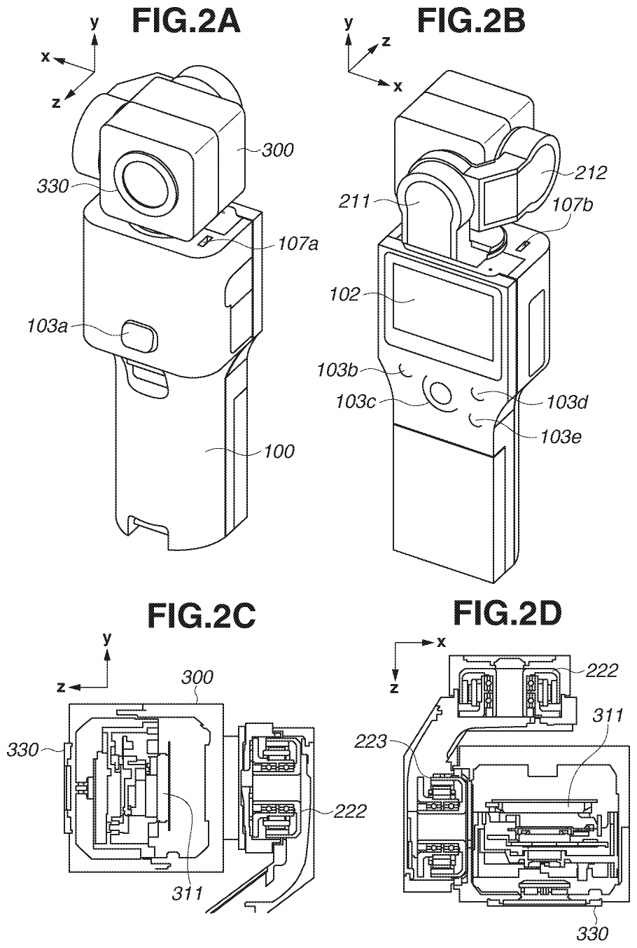

FIGS. 2A and 2B each illustrate an external appearance of the gimbal camera of the present embodiment, and FIGS. 2C and 2D illustrate y-z and x-z cross-sectional views of FIGS. 2A and 2B, respectively.

The apparatus main body 100 includes therein the main body control unit 101, the storage unit 104, the power supply unit 105, and the fan 106 illustrated in FIG. 1. The outer surface of the apparatus main body 100 is provided with the display unit 102, the plurality of input units 103a to 103g, and the air exhaust ports 107a and 107b.

The movable unit 300 is connected to the apparatus main body 100 via the gimbal mechanism 200, and is rotated around the three rotation axes by the gimbal unit 210 of the gimbal mechanism 200. The gimbal unit 210 includes a first support unit 211, a second support unit 212, a first drive unit 221, a second drive unit 222, and a third drive unit 223, each of which is a gimbal structure.

The first support unit 211 is rotatably connected to the apparatus main body 100, and the second support unit 212 is rotatably connected to both the first support unit 211 and the imaging unit 310. The first drive unit 221 drives the first support unit 211, i.e., the movable unit 300, to rotate (pan) about the y-axis with respect to the apparatus main body 100. The second drive unit 222 drives the second support unit 212, i.e., the movable unit 300, to rotate (roll) about the z-axis with respect to the first support unit 211. The third drive unit 223 drives the movable unit 300 to rotate (tilt) about the x-axis with respect to the second support unit 212. In other words, by being coupled to the apparatus main body 100 via the first support unit 211 and the second support unit 212, the movable unit 300 can be rotated about the three axes with respect to the apparatus main body 100.

An image stabilization operation of the gimbal camera of the present embodiment will now be described. The gimbal camera tilts in accordance with a tilt of the user's hand holding the apparatus main body 100. The gimbal camera also vibrates due to vibration (hand shake) of the hand holding the apparatus main body 100 or due to the user's movement, such as walking. This may cause moving images captured by the imaging unit 310 to be tilted or shaken.

For this reason, in the present embodiment, the spatial orientation of the movable unit 300 is controlled via rotational driving by the first to third drive units 221 to 223, stabilizing the moving images captured by the imaging unit 310 at a certain tilt and reducing image shake. For example, the spatial orientation of the movable unit 300 is controlled so that the moving image remains horizontal all times regardless of a tilt of the user's hand and a moving image with reduced image shake due to vibration is obtained. These operations of reducing tilt and image shake are referred to as the image-stabilization operation. Further, separately from the image stabilization operation performed by the first to third drive units 221 to 223, an image stabilization operation may also be performed by shift driving of the image sensor 311 in the imaging unit 310.

The panning operation, a tilting operation and a rolling operation of the gimbal camera of the present embodiment will now be described.

When the user operates the input unit 103 to instruct the panning operation, the main body control unit 101 illustrated in FIG. 1 controls the spatial orientation (the rotational position) of the imaging unit 310 in a pan direction using the first drive unit 221 so that the imaging angle of view of the imaging unit 310 changes in the pan direction.

When the user operates the input unit 103 to instruct the tilting operation, the main body control unit 101 controls the spatial orientation of the imaging unit 310 in a tilt direction using the third drive unit 223 so that the imaging angle of view of the imaging unit 310 changes in the tilt direction.

When the user operates the input unit 103 to instruct the roll operation, the main body control unit 101 controls the spatial orientation of the imaging unit 310 in a roll direction using the second drive unit 222 so that the imaging angle of view of the imaging unit 310 changes in the roll direction.

The main body control unit 101 is also capable of controlling the driving of the first to third drive units 221 to 223 to change the orientation of the imaging unit 310 in the pan, tilt, and roll directions so as to track a specific subject (for example, a moving object) in the moving image captured by the imaging unit 310.

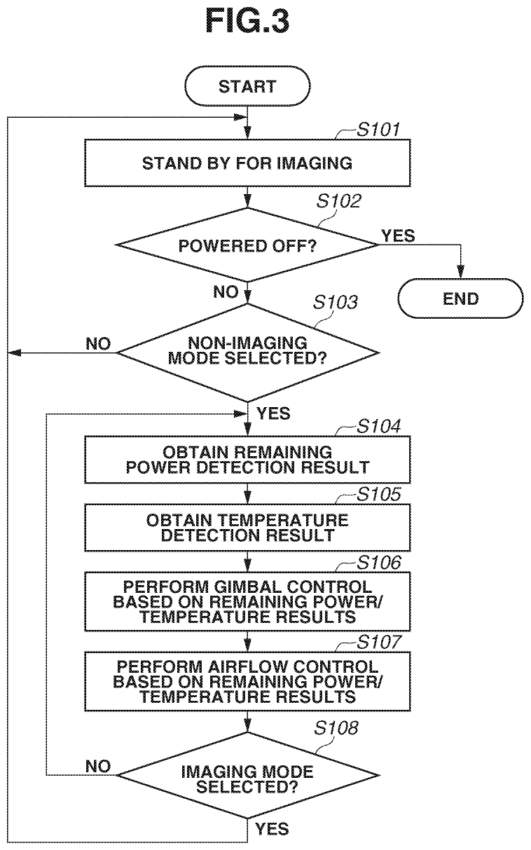

A gimbal operation in a non-imaging mode of the gimbal camera of the present embodiment will now be described with reference to FIGS. 3 to 6.

FIG. 3 illustrates a flowchart of operations of the gimbal camera of the first embodiment. In response to the gimbal camera being powered on, the main body control unit 101 is activated, power is supplied to each unit, and the imaging unit 310 captures an optical image formed by the optical system in the lens unit 330, so that the image is displayed on the display unit 102.

In step S101, the camera enters an imaging standby state in which the next operation is to be determined based on the user's operation via the input unit 103.

In step S102, it is determined whether the gimbal camera is powered off by the user.

If the gimbal camera is powered off by the user (YES in step S102), the power supply from the power supply unit 105 to each unit is shut off, the image capturing by the imaging unit 310 is terminated, and the gimbal camera is brought into a state in which no operations from the user are received.

If the gimbal camera is powered off by the user (NO in step S102), the process proceeds to step S103. In step S103, the gimbal camera waits for an input from the user.

In step S103, it is determined whether the non-imaging mode, such as playback of a recorded moving image or change in settings for image capturing, is selected based on the user's operation via the input unit 103. If the non-imaging mode is not selected (NO in step S103), the process returns to step S101. In step S101, the gimbal camera remains in the imaging standby state. If the non-imaging mode is selected (YES in step S103), the process proceeds to step S104.

In step S104, in order to change the control of the gimbal unit 210 based on a remaining battery level described below via the main body control unit 101, information about the remaining battery level from the power supply unit 105 is detected and stored in the storage unit 104, and the process proceeds to step S105.

In step S105, in order to change the control of the gimbal unit 210 based on a temperature detection result as described below, temperature information from the imaging unit temperature detection unit 320 is detected and stored in the storage unit 104, and the process proceeds to step S106.

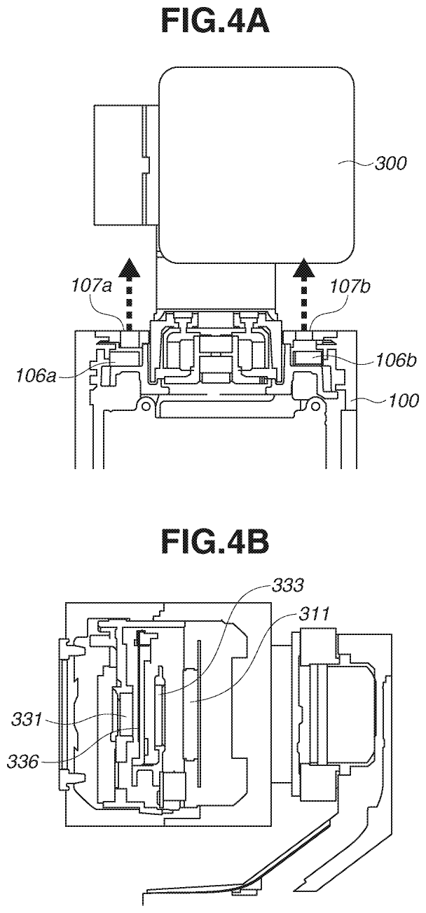

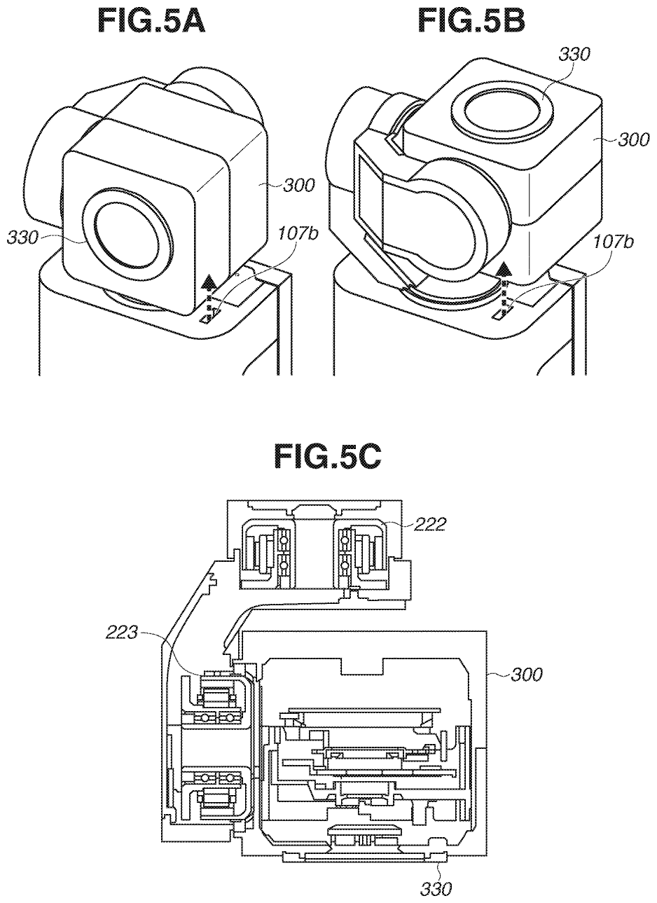

In step S106, the gimbal unit 210 is controlled based on the information about the remaining battery level obtained in step S104 and the temperature information obtained in step S105. Detailed description will be given with reference to FIGS. 4A to 5C.

FIGS. 4A and 4B are cross-sectional views of the gimbal camera and the movable unit 300 in the imaging standby state. FIGS. 5A and 5B are external views of the gimbal camera and the movable unit 300 before and after changing the control of the gimbal unit 210 based on the information about the remaining battery level and the temperature information, respectively, and FIG. 5C is a cross-sectional view of the gimbal camera and the movable unit 300 before changing the control of the gimbal unit 210 based on the information about the remaining battery level and the temperature information.

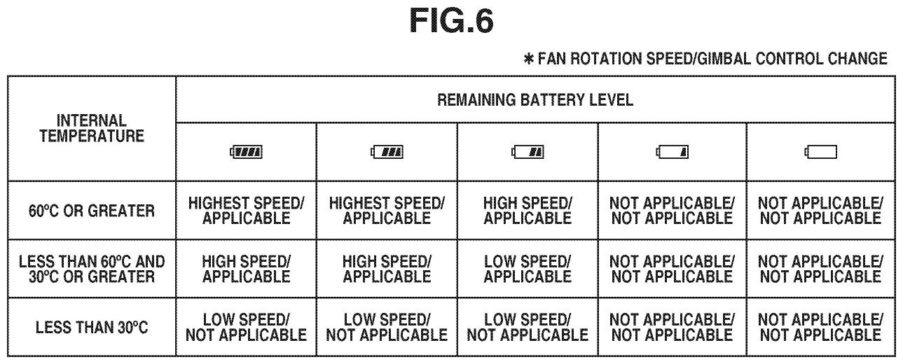

FIG. 6 is a table illustrating the gimbal control based on a remaining battery level and an internal temperature.

As illustrated in FIG. 4A, air blown by the fans 106a and 106b of the forced air-cooling mechanism built in the apparatus main body 100 is discharged toward the movable unit 300 from the air exhaust ports 107a and 107b.

As illustrated in FIG. 4B, the image sensor 311 is disposed in the movable unit 300 on the side closer to the surface opposite the lens unit 330. Thus, heat generated by the image sensor 311 is concentrated on the side opposite from the lens unit 330 in the movable unit 300. Consequently, as illustrated in FIG. 5B, the first drive unit 221 is rotationally driven by 90 degrees, and the third drive unit 223 is rotationally driven by 90 degrees. Further, by moving the surface of the movable unit 300 opposite from the lens unit 330 to a position closer to the air exhaust port 107b than that in FIG. 5A, heat dissipation efficiency can be increased. In other words, the imaging unit 310 is positioned in air flow generated by the forced air-cooling mechanism.

Further, in order to increase heat dissipation efficiency, the first support unit 211 and the second support unit 212 may be made of a material having higher thermal conductivity (for example, metal), and the first support unit 211 and the second support unit 212 may be moved to positions closer to the air exhaust port 107a or the air exhaust port 107b. In other words, the first support unit 211 and the second support unit 212 are positioned in the air flow generated by the forced-air cooling mechanism.

Returning to FIG. 3, in step S107, the rotational speed of the fan 106 is changed based on the information about the remaining battery level obtained in step S104 and the temperature information obtained in step S105. Thus, as illustrated in FIG. 6, when the remaining battery level is high or when the internal temperature has risen significantly to a high temperature, the rotational speed of the fan is controlled to increase with priority given to heat dissipation efficiency. On the other hand, when the remaining battery level is low or when the internal temperature is low due to a small temperature rise, the rotational speed of the fan is reduced or the fan is stopped with priority given to maintaining power for image capturing.

In step S108, it is determined whether an imaging mode is selected based on the user's operation via the input unit 103. If the imaging mode is not selected (NO in step S108), the process proceeds to step S104, and if the imaging mode is selected (YES in step S108), the process proceeds to step S101. In step S101, the gimbal camera enters the imaging standby state.

As described above, according to the first embodiment, heat dissipation performance can be increased by bringing a heat source closer to air flow generated by the forced air-cooling mechanism for air discharged from the air exhaust port 107 based on the information about the remaining battery level from the power supply unit 105 and the internal temperature information from the imaging unit temperature detection unit 320. This makes it possible to extend the moving image capturing time before the moving image capturing function is restricted.

### Second Embodiment

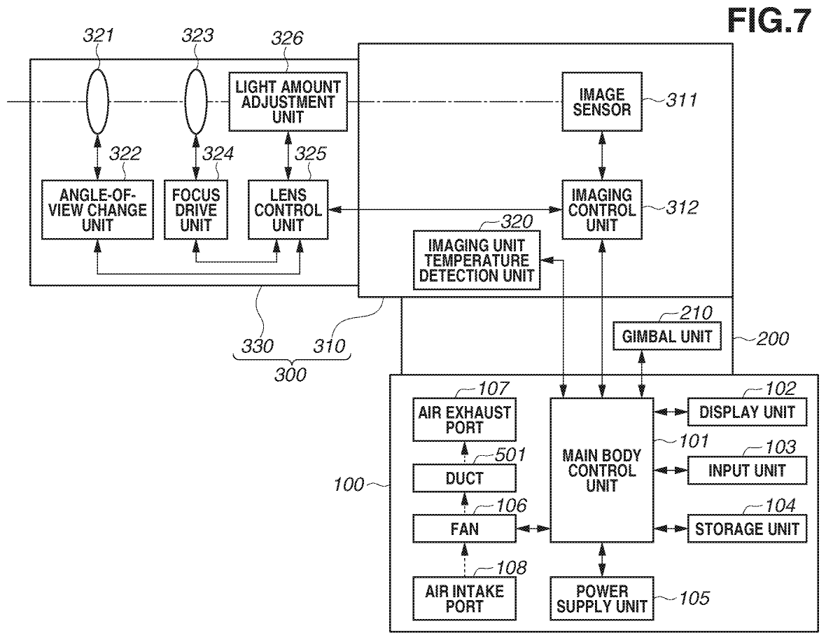

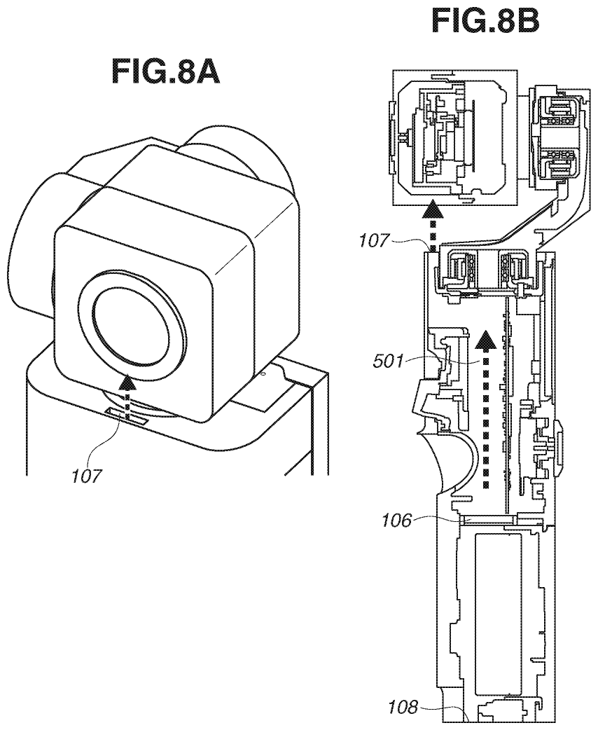

FIG. 7 is a block diagram illustrating a configuration of a gimbal camera in the second embodiment, and FIGS. 8A and 8B are an external view and a cross-sectional view of the gimbal camera, respectively. A basic configuration of the gimbal camera is the same as that in the first embodiment except that the positions of a fan 106 and an air exhaust port 107 are different from those illustrated in FIG. 1. Operations of the gimbal camera are the same as those in the first embodiment, and thus the redundant description will be omitted.

As illustrated in FIGS. 7, 8A, and 8B, the gimbal camera of the second embodiment includes a duct 501 that connects the fan 106 and the air exhaust port 107. Thus, air blown from the fan 106 passes through the duct 501 and is discharged from the air exhaust port 107.

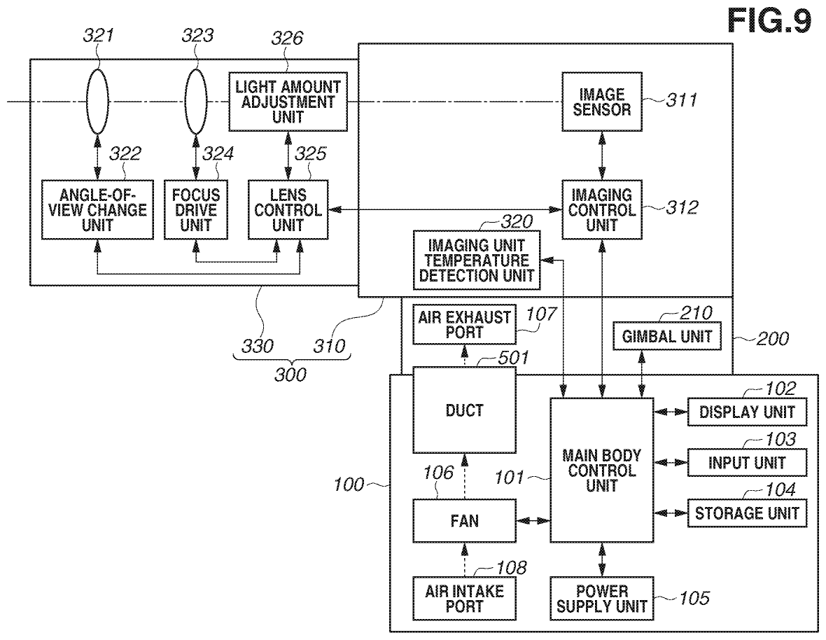

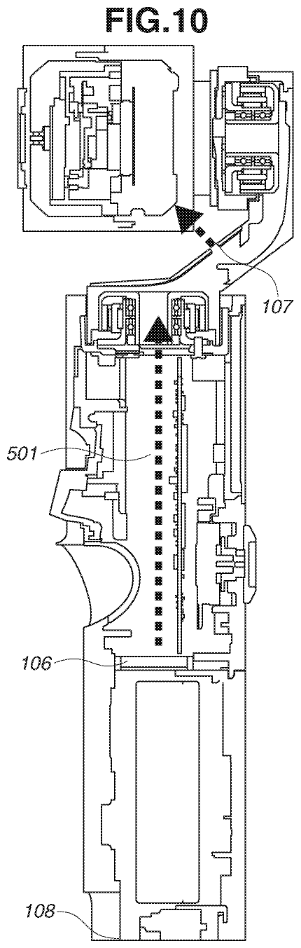

FIG. 9 is a block diagram illustrating a configuration of a gimbal camera according to a modification of the second embodiment, and FIG. 10 is a cross-sectional view of the gimbal camera. In the present modification, an air exhaust port 107 is provided in a gimbal unit 210, and a duct 501 runs from an apparatus main body 100 to the gimbal unit 210. As in FIGS. 7, 8A, and 8B, air blown from the fan 106 passes through the duct 501 and is discharged from the air exhaust port 107.

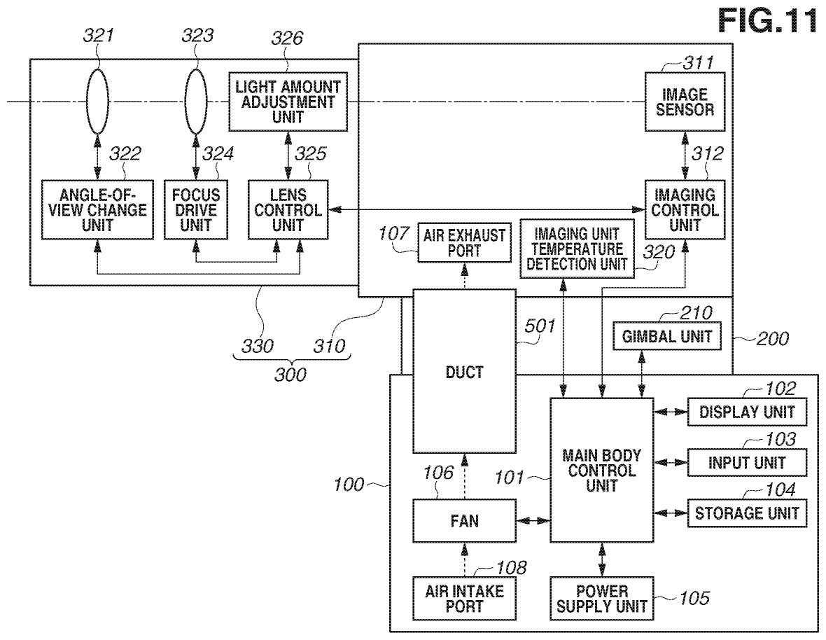

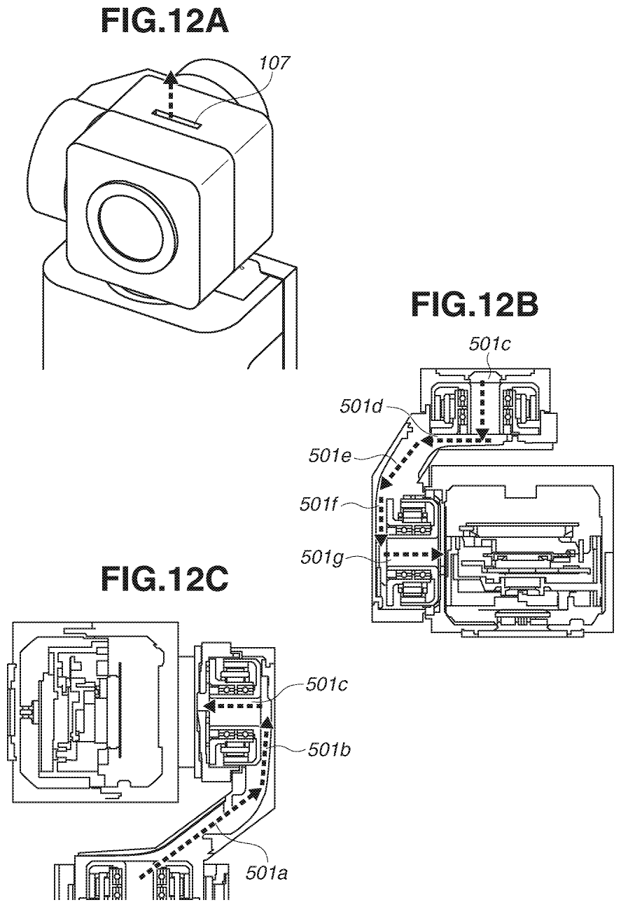

FIG. 11 is a block diagram illustrating a configuration of a gimbal camera in another modification of the second embodiment. FIG. 12A is an external view of the gimbal camera, and FIGS. 12B and 12C are each cross-sectional views of the gimbal camera. In the present modification, an air exhaust port 107 is provided in a movable unit 300, and a duct 501 runs from an apparatus main body 100 to a gimbal unit 210 and a movable unit 300. In the present modification, air blown from a fan 106 also passes through ducts 501a to 501g and is discharged from the air exhaust port 107.

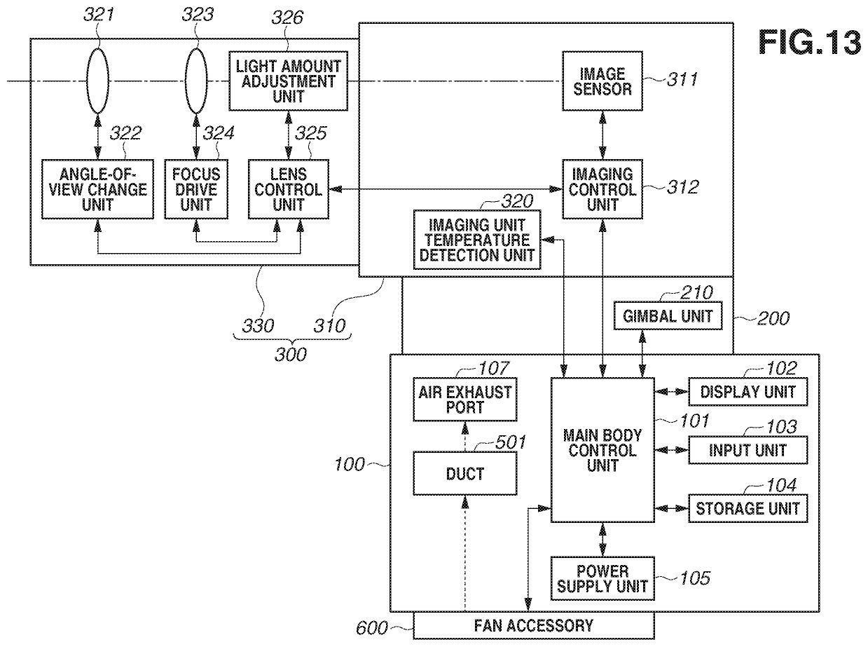

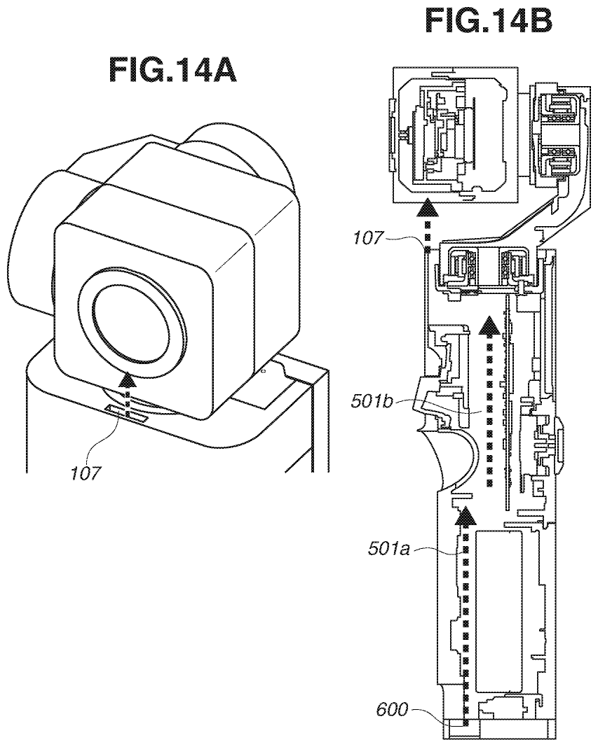

FIG. 13 is a block diagram illustrating a configuration of a gimbal camera in yet another modification of the second embodiment, and FIGS. 14A and 14B are an external view and a cross-sectional view of the gimbal camera, respectively. In the present modification, a fan accessory 600 is attached to the gimbal camera. A duct 501 runs through an apparatus main body 100 and connects the fan accessory 600 attached to the apparatus main body 100 to an air exhaust port 107. Air blown from the fan accessory 600 passes through the duct 501 and is discharged from the air exhaust port 107.

### Third Embodiment

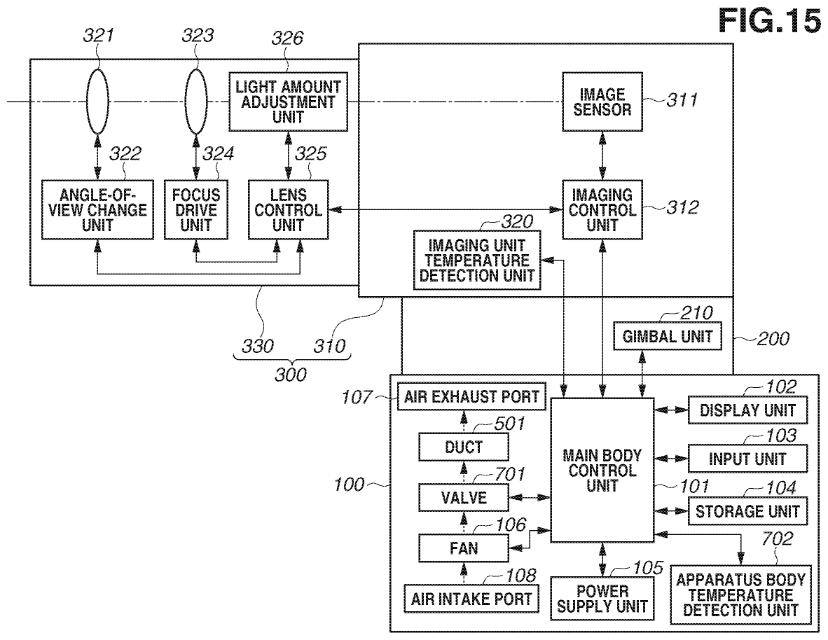

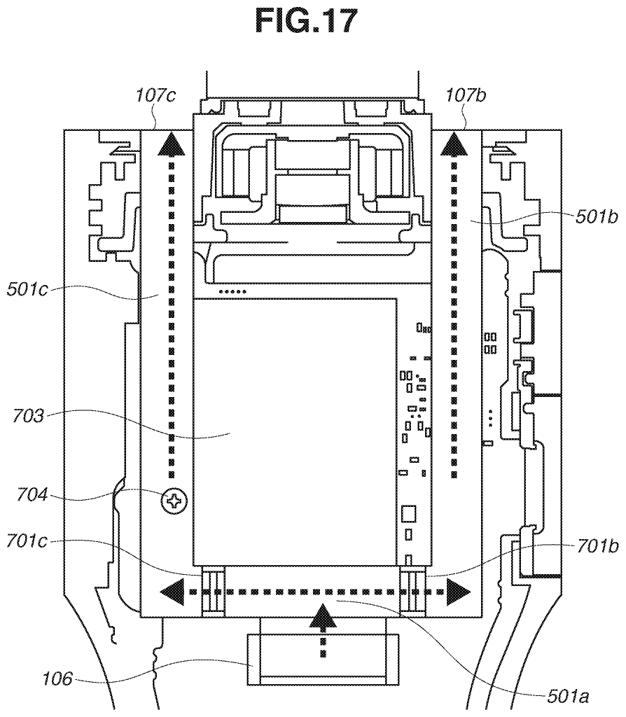

FIG. 15 is a block diagram illustrating a configuration of a gimbal camera in a third embodiment, and FIG. 17 is a cross-sectional view of the gimbal camera. The gimbal camera of the third embodiment includes a plurality of ducts, and includes valves 701, an apparatus main body temperature detection unit 702, and an imaging unit temperature detection unit 320 as components for adjusting the amount of air passing through each duct.

As illustrated in FIG. 17, after passing through a duct 501a, air blown from the fan 106 is branched and supplied to ducts 501b and 501c, and then is discharged from air exhaust ports 107b and 107c, respectively. A heat transfer member 703 is connected to the duct 501c with a screw 704 to transfer heat generated inside the apparatus main body 100 to the duct 501c. A valve 701b is provided between the duct 501a and the duct 501b, and a valve 701c is provided between the duct 501a and the duct 501c.

The valves 701b and 701c provided corresponding to the plurality of ducts are controlled by the main body control unit 101 to change the opening diameters based on temperature information from the imaging unit temperature detection unit 320 and the apparatus main body temperature detection unit 702. The apparatus main body temperature detection unit 702 is electrically connected to the main body control unit 101 to transmit the detected temperature information about the apparatus main body 100 to the main body control unit 101.

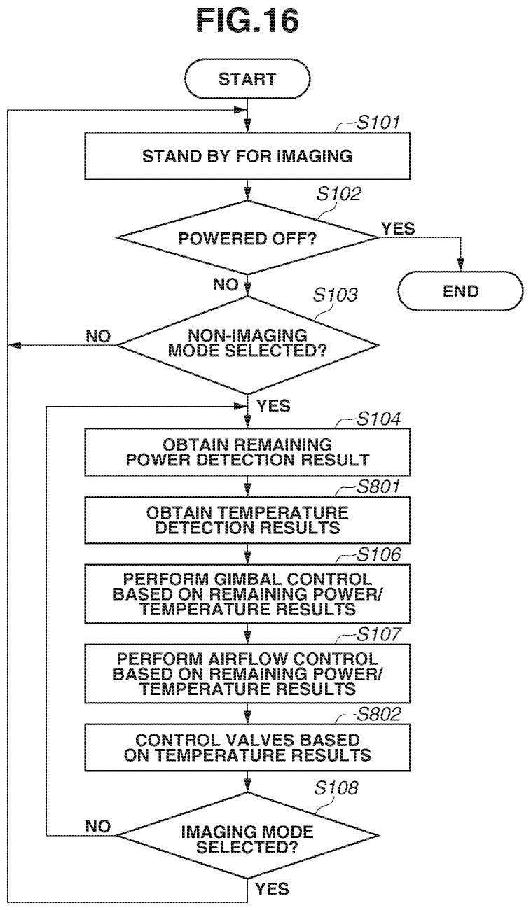

FIG. 16 is a flowchart of operations of the gimbal camera according to the third embodiment. Compared with the operation flowchart of the first embodiment described with reference to FIG. 3, step S105 is replaced with step S801, and step S802 is added.

In step S101, the camera enters an imaging standby state in which the next operation is to be determined based on the user's operation via the input unit 103.

In step S102, it is determined whether the gimbal camera is powered off by the user.

If the gimbal camera is powered off by the user (YES in step S102), the power supply from the power supply unit 105 to each unit is shut off, the image capturing by the imaging unit 310 is terminated, and the gimbal camera is brought into a state in which no operations from the user are received.

If the gimbal camera is not powered off by the user (NO in step S102), the process proceeds to step S103. The gimbal camera waits for an input from the user.

In step S103, it is determined whether a non-imaging mode, such as playback of a recorded moving image or change in settings for image capturing, is selected based on the user's operation via the input unit 103. If the non-imaging mode is not selected (NO in step S103), the process returns to step S101. In step S101, the gimbal camera remains in the imaging standby state. If the non-imaging mode is selected (YES in step S103), the process proceeds to step S104.

In step S104, information about the remaining battery level from the power supply unit 105 is detected and stored in the storage unit 104 via the main body control unit 101 in order to change the control of the gimbal unit 210 depending on the remaining battery level described below, and the process proceeds to step S801.

In step S801, temperature information from the imaging unit temperature detection unit 320 and temperature information from the apparatus main body temperature detection unit 702 are detected and stored in the storage unit 104.

In step S106, the gimbal unit 210 is controlled based on the information about the remaining battery level obtained in step S104 and the temperature information obtained in step S801. In other words, the control operation described with reference to FIGS. 4A to 5C is performed.

In step S107, the rotational speed of the fan 106 is changed based on the information about the remaining battery level obtained in step S104 and the temperature information obtained in step S801. Thus, when the remaining battery level is high or when the internal temperature has risen significantly to be a high temperature, the rotational speed of the fan is controlled to increase with priority given to heat dissipation efficiency. On the other hand, when the remaining battery level is low or when the internal temperature is low due to a small temperature rise, the rotational speed of the fan is reduced or the fan is stopped, with priority given to maintaining power for image capturing.

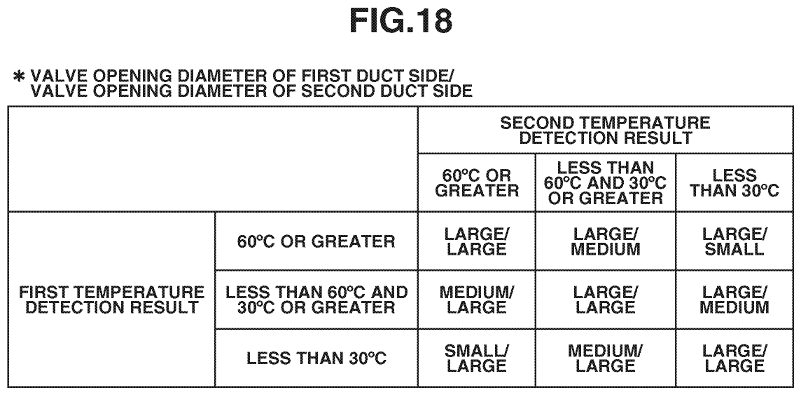

In step S802, the opening diameters of the valves 701b and 701c are changed based on a first temperature detection result detected by the imaging unit temperature detection unit 320 and a second temperature detection result detected by the apparatus main body temperature detection unit 702 in step S801. Detailed description will be given with reference to FIG. 18.

FIG. 18 is a table illustrating the opening diameters of the valves 701b and 701c that are changed based on the first and second temperature detection results. As illustrated in FIG. 18, when the first temperature detection result from the imaging unit temperature detection unit 320 is higher than the second temperature detection result from the apparatus main body temperature detection unit 702, the opening diameter of the valve 701b is increased whereas the opening diameter of the valve 701c is decreased. In this manner, the amount of air supplied to the duct 501b increases, causing a larger amount of air to be discharged from the air exhaust port 107b. Consequently, the heat dissipation efficiency of the movable unit 300 is increased.

Further, when the first temperature detection result from the imaging unit temperature detection unit 320 is lower than the second temperature detection result from the apparatus main body temperature detection unit 702, the opening diameter of the valve 701b is decreased whereas the opening diameter of the valve 701c is increased. In this manner, the amount of air supplied to the duct 501c increases, causing a larger amount of air to be discharged from the air exhaust port 107c. Consequently, the heat dissipation efficiency of the apparatus main body 100 is increased.

Returning to FIG. 3, in step S108, it is determined whether the imaging mode is selected based on the user's operation via the input unit 103. If the imaging mode is not selected (NO in step S108), the process proceeds to step S104. If the imaging mode is selected (YES in step S108), the process proceeds to step S101. In step S101, the gimbal camera enters the imaging standby state.

As described above, in the third embodiment, the opening diameters of the valves 701b and 701c are controlled based on the temperature information from the imaging unit temperature detection unit 320 and the temperature information from the apparatus main body temperature detection unit 702. This makes it possible to efficiently increase heat dissipation performance based on the amounts of heat generated by the apparatus main body 100 and the movable unit 300, extending the moving image capturing time before the moving image capturing function is restricted.

### Fourth Embodiment

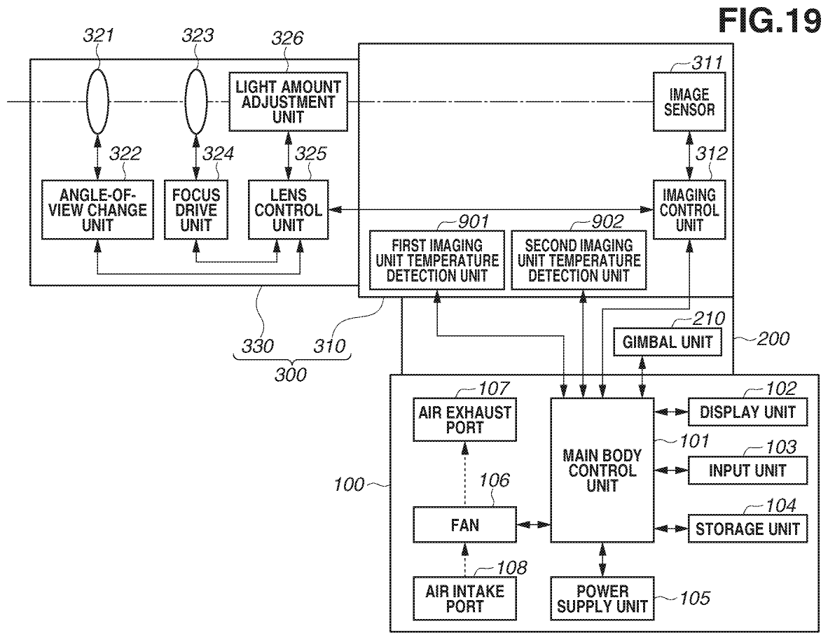

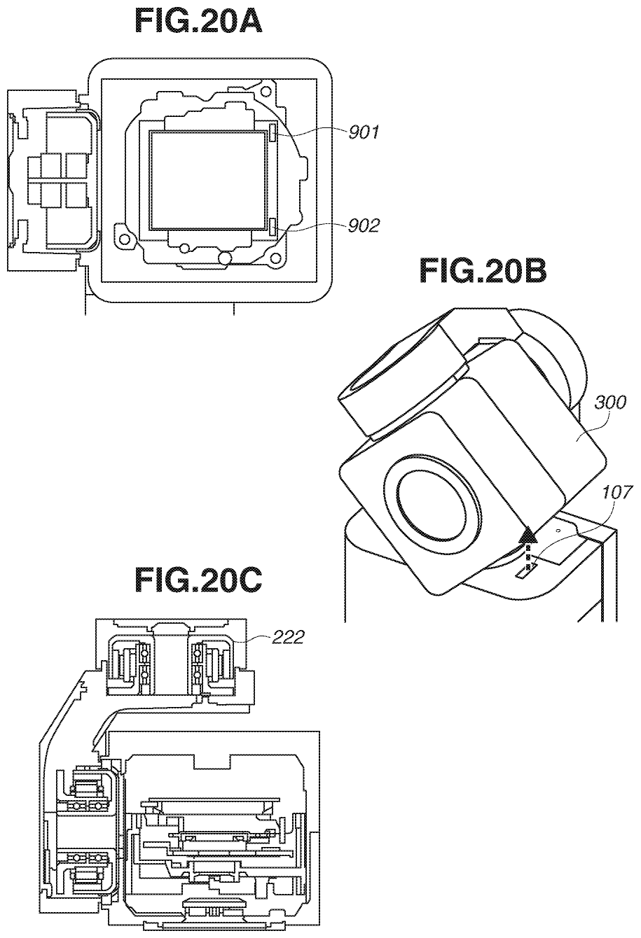

FIG. 19 is a block diagram illustrating a configuration of a gimbal camera according to a fourth embodiment. FIGS. 20A and 20C are each a cross-sectional view of the gimbal camera, and FIG. 20B is an external view of the gimbal camera. The gimbal camera according to the fourth embodiment includes a plurality of temperature detection units in a movable unit 300. The gimbal camera is controlled based on each temperature detection result. Thus, the imaging unit temperature detection unit 320 described in FIG. 1 of the first embodiment is replaced with a first imaging unit temperature detection unit 901 and a second imaging unit temperature detection unit 902. The first imaging unit temperature detection unit 901 and the second imaging unit temperature detection unit 902 are electrically connected to a main body control unit 101 to transmit detected temperature information about an imaging unit 310 to the main body control unit 101.

As illustrated in FIG. 20A, the first imaging unit temperature detection unit 901 and the second imaging unit temperature detection unit 902 are arranged separately on the side close to the movable unit 300 and on the side close to an apparatus main body 100. In this case, when the temperature detection result from the second imaging unit temperature detection unit 902 is higher than the temperature detection result from the first imaging unit temperature detection unit 901, a second drive unit 222 is rotationally driven by 45 degrees as illustrated in FIG. 20B. The movable unit 300 is then moved so that the high-temperature portion is positioned closer to an air exhaust port 107, increasing heat dissipation efficiency.

As described above, in the fourth embodiment, the movable unit 300 includes a plurality of temperature detection units, and by controlling the gimbal camera based on temperature detection results, heat dissipation performance is efficiently increased based on the amount of heat generated. This makes it possible to extend the moving image capturing time before the moving image capturing function is restricted.

While the embodiments of the present disclosure have been described above, the present disclosure is not limited to those embodiments, and various modifications and changes can be made within the gist of the present disclosure.

### Other Embodiments

The present disclosure can also be implemented by a process in which a program that carries out one or more functions of the above-described embodiments is supplied to a system or an apparatus via a network or a storage medium, and one or more processors in a computer of the system or the apparatus read and execute the program. The present disclosure can also be implemented with a circuit (for example, an Application Specific Integrated Circuit (ASIC)) that carries out one or more functions.

The disclosure of the present embodiments includes the following configurations.

### Configuration 1

An imaging apparatus comprising:
an apparatus main body;
an imaging unit;
a first support unit rotatably connected to the apparatus main body;
   a second support unit rotatably connected to both the first support unit and the imaging unit;
a first driver configured to rotate the first support unit with respect to the apparatus main body about a first axis;
a second driver configured to rotate the second support unit with respect to the first support unit about a second axis orthogonal to the first axis;
   a third driver configured to rotate the imaging unit with respect to the second support unit about a third axis orthogonal to both the first axis and the second axis; and
   a controller configured to, in a non-imaging mode, control the first driver, the second driver, and the third driver so that the imaging unit is positioned in air flow generated by a forced air-cooling mechanism.

### Configuration 2

The imaging apparatus according to configuration 1, wherein the controller controls the first driver, the second driver, and the third driver so that a portion of the imaging unit at which a high temperature is detected by a temperature detector is positioned in the air flow generated by the forced air-cooling mechanism.

### Configuration 3

The imaging apparatus according to configuration 1 or 2, wherein, in the non-imaging mode, the controller controls the first driver, the second driver, and the third driver so that the first support unit or the second support unit is positioned in the air flow generated by the forced air-cooling mechanism.

### Configuration 4

The imaging apparatus according to any one of configurations 1 to 3, wherein the controller controls a rotational speed of a fan of the forced air-cooling mechanism based on a temperature detected by a temperature detector.

### Configuration 5

The imaging apparatus according to any one of configurations 1 to 4, wherein the controller controls a rotational speed of a fan of the forced air-cooling mechanism based on a remaining battery level.

### Configuration 6

The imaging apparatus according to any one of configurations 1 to 5, further comprising a duct through which air blown from a fan of the forced air-cooling mechanism passes.

### Configuration 7

The imaging apparatus according to configuration 6, further comprising a valve for adjusting an amount of air passing through the duct,
wherein the controller controls an opening of the valve based on the temperature detected by a temperature detector.

### Configuration 8

The imaging apparatus according to configuration 7, further comprising a plurality of the valves corresponding to a plurality of the ducts,
wherein the controller controls the openings of the valves to adjust the amount of air passing through each of the ducts based on the temperature detected by the temperature detector.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2025-044713, filed Mar. 19, 2025, which is hereby incorporated by reference herein in its entirety.

What is claimed is:

1. An imaging apparatus comprising:
an apparatus main body;
an imaging unit;
a first support unit rotatably connected to the apparatus main body;
a second support unit rotatably connected to both the first support unit and the imaging unit;
a first driver configured to rotate the first support unit with respect to the apparatus main body about a first axis;
a second driver configured to rotate the second support unit with respect to the first support unit about a second axis orthogonal to the first axis;
a third driver configured to rotate the imaging unit with respect to the second support unit about a third axis orthogonal to both the first axis and the second axis; and
a controller configured to, in a non-imaging mode, control the first driver, the second driver, and the third driver so that the imaging unit is positioned in air flow generated by a forced air-cooling mechanism.

2. The imaging apparatus according to claim 1, wherein the controller controls the first driver, the second driver, and the third driver so that a portion of the imaging unit at which a high temperature is detected by a temperature detector is positioned in the air flow generated by the forced air-cooling mechanism.

3. The imaging apparatus according to claim 1, wherein, in the non-imaging mode, the controller controls the first driver, the second driver, and the third driver so that the first support unit or the second support unit is positioned in the air flow generated by the forced air-cooling mechanism.

4. The imaging apparatus according to claim 1, wherein the controller controls a rotational speed of a fan of the forced air-cooling mechanism based on a temperature detected by a temperature detector.

5. The imaging apparatus according to claim 1, wherein the controller controls a rotational speed of a fan of the forced air-cooling mechanism based on a remaining battery level.

6. The imaging apparatus according to claim 1, further comprising a duct through which air blown from a fan of the forced air-cooling mechanism passes.

7. The imaging apparatus according to claim 6, further comprising a valve for adjusting an amount of air passing through the duct,
wherein the controller controls an opening of the valve based on the temperature detected by a temperature detector.

8. The imaging apparatus according to claim 7, further comprising a plurality of the valves corresponding to a plurality of the ducts,
wherein the controller controls the openings of the valves to adjust the amount of air passing through each of the ducts based on the temperature detected by the temperature detector.

9. An imaging apparatus comprising:
an apparatus main body;
an imaging unit including an image sensor;
a first support unit rotatably connected to the apparatus main body;
a second support unit rotatably connected to both the first support unit and the imaging unit;
a first driver configured to rotate the first support unit with respect to the apparatus main body about a first axis;
a second driver configured to rotate the second support unit with respect to the first support unit about a second axis orthogonal to the first axis;
a third driver configured to rotate the imaging unit with respect to the second support unit about a third axis orthogonal to both the first axis and the second axis; and
a controller configured to, in a non-imaging mode, control at least one of the first driver, the second driver, and the third driver so that the image sensor is arranged closer to an air exhaust port provided in the apparatus main body than in an imaging standby state.

10. The imaging apparatus according to claim 9, wherein, in the non-imaging mode, the controller controls the first driver, the second driver, and the third driver so that the first support unit or the second support unit is positioned in the air flow generated by a forced air-cooling mechanism.

11. The imaging apparatus according to claim 9, wherein the controller controls a rotational speed of a fan of the forced air-cooling mechanism based on a temperature detected by a temperature detector.

12. The imaging apparatus according to claim 9, wherein the controller controls a rotational speed of a fan of the forced air-cooling mechanism based on a remaining battery level.

13. The imaging apparatus according to claim 9, further comprising a duct through which air blown from a fan of the forced air-cooling mechanism passes.

14. The imaging apparatus according to claim 13, further comprising a valve for adjusting an amount of air passing through the duct,
wherein the controller controls an opening of the valve based on the temperature detected by a temperature detector.

15. The imaging apparatus according to claim 14, further comprising a plurality of the valves corresponding to a plurality of the ducts,
wherein the controller controls the openings of the valves to adjust the amount of air passing through each of the ducts based on the temperature detected by the temperature detector.
